(19) United States
(12) Patent Application Publication
(10) Pub. No.: US 2022/0297111 A1
(43) Pub. Date: Sep. 22, 2022

(54) PIPETTING DEVICE

(71) Applicant: BRAND GMBH + CO KG, Wertheim (DE)

(72) Inventors: Tom GREIN, Wertheim (DE); Markus KURZ, Wertheim (DE)

(73) Assignee: BRAND GMBH + CO KG, Wertheim (DE)

(21) Appl. No.: 17/684,755

(22) Filed: Mar. 2, 2022

(30) Foreign Application Priority Data
Mar. 5, 2021 (DE) 20 2021 101 129.7

(51) Int. Cl. B01L 3/02; G01N 35/10

(52) U.S. Cl. CPC B01L 3/0217; G01N 35/1016; G01N 2035/1027; B01L 2200/023; B01L 2200/04; B01L 2200/087; B01L 2300/0609; B01L 2400/049; B01L 2200/0605

(57) ABSTRACT

A pipetting device for taking up and dispensing volumes of fluid, which has an ejector mechanism which is actuable by means of an actuating means to eject or release a pipette tip plugged onto the pipetting device. The pipetting device has a coupling mechanism which is configured such that, in the unactuated state, actuating means and ejector mechanism are decoupled, and, when the actuating means is actuated, the latter is coupled to the ejector mechanism, causing a force exerted on the actuating means to transfer to the ejector mechanism. Also, the pipetting device can have a positioning mechanism which, when a pipette tip is not plugged on and the actuating means is unactuated, holds an ejector means, of the ejector mechanism in a basic position which is located between an ejection position and a plug-on position with a pipette tip plugged on.

### BACKGROUND OF THE INVENTION

### Field of the Invention

The invention relates to a pipetting device for taking up and dispensing volumes of liquid.

A pipetting device has a displacement mechanism at which a pipette tip is hermetically attachable and separable again. The displacement mechanism and the pipette tip together form a sealed air space. The displacement mechanism, preferably in the form of a piston-cylinder arrangement, changes the volume of the space and thus enables liquid to be aspirated into, and dispensed from, the pipette tip. A pipetting device can have a plurality of displacement mechanisms with a respective pipette tip. The displacement mechanism can be actuated by hand or by means of a motor. The pipetting device can also be hand-held or part of an automated laboratory system.

The pipette tip can be connected to the displacement mechanism by means of a plug-on connection. For this purpose, on the displacement mechanism, the pipetting device has a tubular endpiece which is of cylindrical or conical design and onto which the pipette tip is plugged by its congruent tubular opening.

For separating or ejecting the pipette tip from the displacement mechanism, an ejector mechanism is provided on the pipetting device in order to release the pipette tip from the endpiece of the displacement mechanism. The ejector mechanism is driven by hand or by means of a motor.

### DESCRIPTION OF THE RELATED ART

European Patent Application EP 0566939 A1 and corresponding U.S. Pat. No. 5,435,197 A disclose, for example, an ejector mechanism which reduces the actuating force for separating the plug-in connection. For this purpose, a step-down gearing is provided which also reduces the actuating distance. Since different pipette tips are available from different manufacturers, and said pipette tips differ geometrically, the relative position of the pipette tips, connected by being plugged on, on the endpiece of the displacement mechanism differs. Such a reduced actuating distance for separating the pipette tip is frequently insufficient to completely release every pipette tip from the endpiece.

International Patent Application Publication WO 2002/00345 A2 and corresponding U.S. Pat. No. 6,749,812 B2, and European Patent Application EP 1 272 825 B1 and corresponding U.S. Pat. No. 6,871,557 B2, disclose ejector mechanisms which release the pipette tip from the displacement mechanism by means of spring force. The compression spring provided for this purpose is clamped previously during the plugging-on. The relative movement between pipette tip and pipetting device is used by an ejector mechanism on the pipetting device being compressed and being held in this position by a locking mechanism. By actuation of a push bottom, the locking can be released such that the compression spring relaxes and drives the ejector mechanism in the direction of the endpiece. Depending on the geometry of the pipette tip, the relative position thereof on the endpiece is such that either the spring force is insufficient to separate the pipette tip or the plug-on connection is not sufficiently strong and hermetically sealed.

### SUMMARY OF THE INVENTION

It is the object of the invention to provide an ejector mechanism on a pipetting device, which reduces the actuating force and/or the actuating distance and at the same time enables the pipette tip to be reliably plugged onto the endpiece of the ejector mechanism and to be separated or ejected.

The above object is achieved by a pipetting device as described herein.

The pipetting device according to the present invention has a displacement mechanism for taking up and dispensing volumes of fluid, an ejector mechanism, and an actuating means.

The displacement mechanism has an endpiece to which a pipette tip can be releasably attached. The displacement mechanism is preferably a piston-cylinder arrangement.

The ejector mechanism is designed to release and to eject a pipette tip attached to the endpiece from the endpiece and from the pipetting device. For this purpose, the ejector mechanism has an ejector means, in particular an ejector sleeve.

For the, in particular manual, actuation of the ejector mechanism, in particular of the ejector means, the pipetting device has an actuating means, in particular an actuating lever or actuating button. By actuation, the actuating means is movable from an inoperative position into an actuating position.

By moving of the actuating means from the inoperative position into the actuating position, the ejector means is moved relative to the endpiece into an ejection position, or the ejector mechanism is configured for this purpose. By this means, a pipette tip attached to the endpiece is moved relative to the endpiece and is finally ejected from the pipetting device. In particular, the ejector means is used to press down the pipette tip from the endpiece and to release its force-fitting connection.

According to one aspect of the invention, the pipetting device has a coupling mechanism which interacts with the actuating means and the ejector mechanism. In the inoperative position of the actuating means, the actuating means and the ejector mechanism are decoupled, or the coupling mechanism is configured in such a way. By actuation of the actuating means or moving of the actuating means, the coupling mechanism couples the actuating means to the ejector mechanism. In other words, the actuating means and the ejector mechanism are decoupled in the inoperative position of the actuating means and are coupled to each other in the actuating position.

The coupling enables a force exerted on the actuating means to be transferrable to the ejector mechanism, in particular to the ejector means. This force is used to move the ejector means into the ejection position and to release and eject the pipette tip from the pipetting device.

In an advantageous manner, coupling takes place between actuating means and ejector mechanism only when the pipette tip is to be ejected or the actuating means is actuated for this purpose. This facilitates the pushing on or plugging on of the pipette tip since, when the pipette tip is plugged on, the ejector mechanism is decoupled from the actuating means. In addition, it can be ensured that, even in the case of pipette tips with different geometries, the pipette tip is reliably plugged on and held, in particular in a hermetically sealed manner, on the one hand, and the pipette tip is reliably and completely separated or ejected, on the other hand. In particular, it can be ensured that the pipette tip is released an always identical, short actuating distance, irrespective of the relative position of the pipette tip with respect to the endpiece, since the ejector means can lie directly on the pipette tip. This leads in particular also to a reduced actuating force and to improved ergonomics for the ejection of the pipette tip carried out by hand.

In the actuating position of the actuating means, the coupling mechanism is preferably in engagement with the ejector mechanism, or can be brought into engagement with the ejector mechanism by moving of the actuating means into the actuating position. In the inoperative position of the actuating means, the coupling mechanism is preferably not in engagement with the ejector mechanism. A particularly simple and reliable coupling mechanism is thereby advantageously achieved. The movement of the actuating means as far as the coupling is relatively short and therefore the movement distance of the actuating means from the inoperative position into the actuating position and ejection position is overall always short and of the same length.

Particularly preferably, the coupling mechanism has an engagement means or engagement element and the ejector mechanism has a mating engagement means or mating engagement element. The engagement for the coupling of ejector mechanism and coupling mechanism is thereby made possible in a particularly simple manner.

The engagement means and the mating engagement means can preferably be brought into form-fitting, force-fitting and/or frictionally locking engagement, or are connected to each other in engagement. By this means, the actuating means is preferably coupled to the ejector mechanism. This permits a particularly simple and/or reliable coupling.

The engagement means and the mating engagement means preferably have teeth which are configured to be in each case mutually complementary at least in regions, for the in particular form-fitting interaction. Instead, the engagement means and the mating engagement means can also intermesh in a force-fitting and/or frictionally locking manner when the actuating means is actuated or the actuating means is coupled to the ejector mechanism via the coupling mechanism. This permits a particularly simple and/or reliable coupling. In addition, different coupling positions can be achieved in a particularly advantageous manner depending on which teeth intermesh and the precision of the tooth spacing. A force-fitting or frictionally locking coupling permits a freely variable coupling position and requires only an identically short actuation as far as the coupling. This is beneficial for a short actuating distance even in the case of the pipette tips having different geometries. In particular, after the pipette tip is plugged on, the ejector means can take up different positions, in particular such that it is located directly on the upper edge of the pipette tip, and nevertheless a reliable and effective coupling is permitted.

The engagement means is preferably guided in a housing of the pipetting device, and/or is movable, in particular displaceable, by means of the actuating means, and/or is movably connected to the actuating means. This permits a particularly simple and reliable coupling in which the engagement means can be guided or moved for engagement in the mating engagement means, for example by means of a slotted guide. In particular, it can thus also be ensured that, in the inoperative position, engagement means and mating engagement means are not in engagement, and actuating means and ejector mechanism are corresponding decoupled.

The engagement means is particularly preferably movable along a longitudinal axis of the pipetting device. By this means, the movability or displaceability of the engagement means is achieved in a particularly simple manner in particular, the actuation of the actuating means can bring about a longitudinal movement or translation of the engagement means.

The engagement means preferably comes into engagement with, or out of engagement with, the mating engagement means by movement at least along the longitudinal axis of the pipetting device. For this purpose, the pipetting device particularly preferably has a guide slot in which the engagement means is guided. The engagement or the coupling is thereby made possible in a particularly simple manner.

Alternatively, or additionally, the engagement means can be rotatable about an axis running transversely with respect to the longitudinal axis of the pipetting device. In particular, in this case, an actuation of the actuating means brings about a rotational movement of the engagement means such that it enters into engagement with the mating engagement means.

By moving of the actuating means into the actuating position, the mating engagement means is preferably movable, in particular displaceable, when the coupling mechanism, in particular the engagement means, is coupled to the ejector mechanism, in particular to the mating engagement means. Particularly preferably, when the actuating means is initially actuated, the coupling mechanism is activated such that the engagement means and mating engagement means enter into engagement, or the actuating means is coupled to the ejector mechanism or the mating engagement means. A further movement of the actuating means into the actuating position brings about a movement or displacement of the coupled mating engagement means. By this means, force is transmitted in a particularly simple manner from the actuating means, via the coupling mechanism or the engagement means, to the ejector mechanism or the mating engagement means.

The mating engagement means is preferably connected to the ejector means in such a manner that a movement, in particular displacement, of the mating engagement means brings about a movement, in particular displacement, of the ejector means. The force exerted by the actuating means can therefore be transmitted in a particularly simple manner via the mating engagement means to the ejector means. By means of this force, the pipette tip can then be reliably and completely separated or ejected from the endpiece or the pipetting device, in particular can be pushed from the endpiece by means of the movable ejector means.

The pipetting device preferably has a pre-tensioning means or pre-tensioning element, in particular a spring. By means of the pre-tensioning means, the ejector means can preferably be pre-clamped, in particular a pre-tensioning force can be exerted on the ejector means counter to an attaching direction or in an ejection direction of the pipetting device. In an advantageous manner, a force is exerted via the pre-tensioning means counter to the attaching direction or in the ejection direction, which can facilitate or assist the ejection.

The ejection direction is preferably understood as meaning the direction in which the ejector means is moved for ejecting the pipette tip, or the direction in which the pipette tip is moved relative to the endpiece during the ejection. The ejection direction is preferably parallel to the longitudinal axis of the pipetting device and/or coincides with the direction in which liquid can be dispensed by means of the pipetting device.

The attaching direction should preferably be understood as meaning the direction in which the pipette tip is moved relative to the endpiece when the pipette tip is plugged or pushed onto the endpiece. The pipette tip is conventionally attached or plugged on by the endpiece being pressed into the pipette tip, i.e., by a movement of the endpiece in the direction opposed to the attaching direction. The attaching direction should therefore be understood only as a relative movement of the pipette tip relative to the endpiece, even though it is actually the endpiece and not the pipette tip which is moved during the attaching. The attaching direction is preferably opposed to the ejection direction and/or is parallel to the longitudinal axis of the pipetting device and/or coincides with the direction in which liquid can be sucked up into the pipetting device.

Preferably, the pre-tensioning means is operatively connected to the ejector means, preferably via the mating engagement means, both when the coupling mechanism is decoupled and also when the latter is coupled. The effect which can thereby be advantageously achieved is that the force which is applied during the plugging on of the pipette tip can be partially stored by clamping of the pre-tensioning means. This force can then be used to facilitate or to assist the ejection.

The ejector means preferably at least partially radially surrounds the endpiece and the endpiece protrudes out of the ejector means through an opening in the ejector means, in particular even in a basic position before a pipette tip has been plugged on. This facilitates the plugging on of a pipette tip.

Particularly preferably, the pre-tensioning force of the pre-tensioning means is selected in such a manner that, in the inoperative position of the actuating means or if actuating means and ejector mechanism are decoupled, the ejector means remains in the basic position, in particular if no pipette tip is plugged thereon. In the basic position, the endpiece protrudes out of the ejector means equally far or further than in the ejection position of the ejector means. This facilitates the plugging on of a pipette tip since, even after a pipette tip has been ejected, the basic position is resumed with the endpiece protruding out to a defined extent, and a new pipette tip can consequently be readily plugged on.

In the inoperative position of the actuating means or if the actuating means and the ejector mechanism are decoupled, the ejector means is preferably movable in the attaching direction until in a plug-on position, in particular counter to the pre-tensioning force of the pre-tensioning means.

The plug-on position is preferably the position of the ejector means when a pipette tip is plugged onto the pipetting device or onto the endpiece. The plug-on position may be different depending on the geometry of the pipette tip. In the plug-on position, the ejector means preferably is located directly on the upper edge of the pipette tip.

If a pre-tensioning means is provided, its pre-tensioning force is preferably selected in such a manner that, when a pipette tip is attached to the endpiece and is adjacent to the ejector means, the ejector means remains in its plug-on position. In particular, the pre-tensioning force is therefore smaller than the retaining force between endpiece and pipette tip. By this means, additional holding mechanisms for the ejector means, such as locking in the plug-on position, can thereby be dispensed with. This is beneficial for a particularly simple construction. In addition, different plug-on positions can be realized, in particular steplessly, depending on the geometry of the pipette tip.

A further aspect of the present invention that can also be realized independently relates to a positioning mechanism of the pipetting device. By means of the positioning mechanism, the ejector means is held in the basic position which is located between the separating position or ejection position and the plug-on position.

It is thereby advantageously ensured that the ejector means without the pipette tip plugged thereon and in the inoperative position of the actuating means is always located in the same position, namely the basic position, or assumes the basic position after a pipette tip has been ejected.

According to the invention, the basic position is located between the plug-on position and the ejection position, in particular, in the basic position, the endpiece therefore protrudes further out of the ejector means than in the ejection position. This is beneficial for particularly simple plugging on or attaching of the pipette tip. In particular, the endpiece can be joined in a simple manner into the opening of the pipette tip or such a joining is facilitated.

Furthermore, when the pipette tip is plugged on, the ejector means is shifted from the (central) basic position into the plug-on position. In the latter, the ejector means and the pipette tip can be in contact, and therefore an empty stroke does not occur during the ejection.

The positioning mechanism preferably comprises a first pre-tensioning means or pre-tensioning element, in particular a first spring, wherein the first pre-tensioning means exerts a pre-tensioning force on the ejector means counter to the attaching direction or in the ejection direction of the pipetting device. By this means, it is made possible in particular for the ejector means during the ejection to also actually be moved into the basic position and not already to remain in a position between the plug-on position and basic position, even if the pipette tip is already ejected before the basic position is reached.

In particular, the first pre-tensioning means can be the pre-tensioning means which has already been mentioned and which is intended to facilitate or assist the ejection. In an advantageous manner, the same pre-tensioning means is used firstly for facilitating or assisting the ejection and secondly for driving the ejector means into the basic position. This is beneficial for a particularly simple construction.

The positioning mechanism preferably has a second pre-tensioning means or pre-tensioning element, in particular a second spring. The second pre-tensioning means is fastened at one end to the ejector means and at the other end to the pipetting device, in particular to the displacement mechanism. Defined by the distance of the two ends from each other, the second pre-tensioning means holds the ejector means in the basic position, in particular over the length and/or pre-tensioning force of the second pre-tensioning means.

The second pre-tensioning means particularly preferably exerts a pre-tensioning force on the ejector means in the attaching direction or counter to the ejection direction, i.e. in particular in a manner opposed to the direction in which the first pre-tensioning means exerts a pre-tensioning force on the ejector means.

It is ensured in an advantageous manner by the second pre-tensioning means that the ejector means, in particular after the ejection, is driven back from the ejection position into the basic position. In particular, the endpiece can thereby be further exposed in order to facilitate the plugging on of a new pipette tip.

The positioning mechanism preferably has a flange element which is seated movably on the displacement mechanism and between a first stop on the displacement mechanism and the second pre-tensioning means, wherein the second pre-tensioning means pushes the flange element against the first stop. It is thereby ensured in a simple manner that the ejector means is not displaced beyond the basic position by the second pre-tensioning means.

The ejector means preferably has a second stop, preferably an integral formation, which, when the ejector means moves counter to the attaching direction, abuts against the flange element and, during a further movement of the ejector means, in particular driven by the first pre-tensioning means and/or by the actuating means, entrains the flange element counter to the action of the pre-tensioning force of the second pre-tensioning element in a manner moving away from the stop. A movement of the ejector means beyond the basic position into the ejection position, in particular counter to the force of the second pre-tensioning means, is thereby realized in a simple manner.

The first pre-tensioning means preferably pushes the ejector means against the flange element counter to the attaching direction and holds the ejector means in the basic position. This permits a particularly reliable remaining of the ejector means in the basic position.

When the actuating means is shifted from the actuating position into the inoperative position, the ejector means is preferably moved into its basic position by the pre-tensioning force of the second pre-tensioning means. In particular, after a pipette tip has been ejected, the ejector means resumes the basic position and the actuating means the inoperative position in which actuating means and ejector mechanism are decoupled from each other.

The actuating means preferably has a step-down mechanism for the actuation from the inoperative position into the actuating position. By this means, the force which is required for the ejection, can be reduced in an advantageous manner, and therefore the use is facilitated.

The step-down mechanism particularly preferably has a lever with a rotary bearing, which is fixed on the housing, at one end, an actuating button at another end and, in-between, a rotary bearing for connecting the actuating means to the ejector mechanism or to the coupling mechanism. A stepping down is thereby realized in a particularly simple manner, which is beneficial in particular for a simple construction.

The aforementioned aspects and features of the present invention and the aspects and features of the present invention that emerge from the further description can be realized independently of one another, but also in any desired combination.

Further advantages, features, properties and aspects of the present invention will be apparent the description below of preferred embodiments with reference to the accompanying drawings.

### BRIEF DESCRIPTION OF THE DRAWINGS

FIG. 1 is a schematic section through a pipetting device according to the invention according to a first embodiment before plugging on of a pipette tip and an actuating means in the inoperative position;

FIG. 2 is a schematic section of the pipetting device according to the first embodiment with plugged-on pipette tip and the actuating means in the inoperative position;

FIG. 3 is a schematic section of the pipetting device according to the first embodiment with plugged-on pipette tip and the actuating means in the coupling position;

FIG. 4 is a schematic section of the pipetting device according to the first embodiment with the actuating means in the actuating position when the pipette tip is ejected;

FIG. 5 is a schematic section of a pipetting device according to a second embodiment in a position corresponding to FIG. 1;

FIG. 6 is a schematic section of the pipetting device according to the second embodiment in a position corresponding to FIG. 2;

FIG. 7 is a schematic section through the pipetting device according to the second embodiment corresponding to the position in FIG. 3; and

FIG. 8 is a schematic section through the pipetting device according to the second embodiment in a position corresponding to FIG. 4.

### DETAILED DESCRIPTION OF THE INVENTION

In the figures, the same reference signs are used for identical or similar parts, with corresponding properties and advantages being achieved, although a repeated description has been omitted for reasons of simplification.

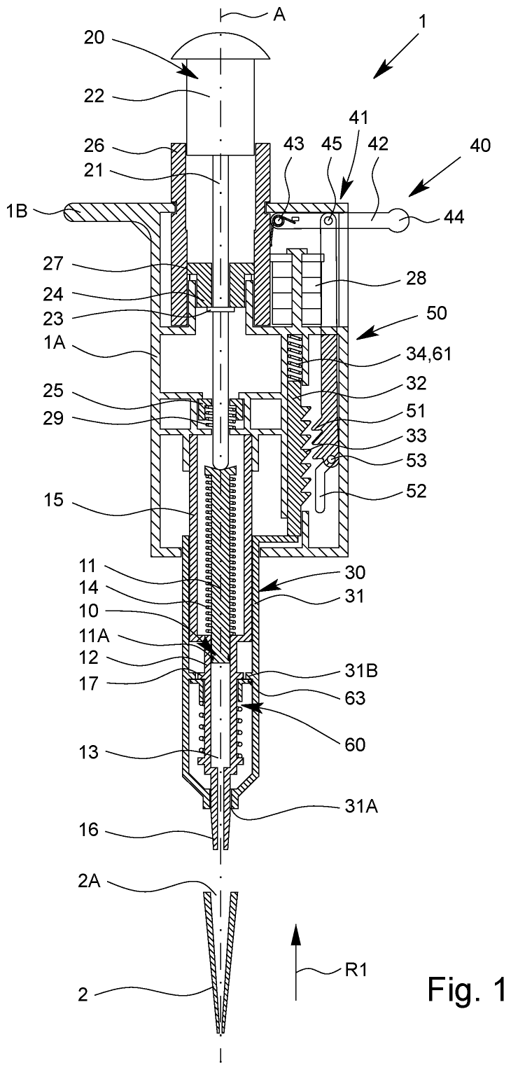

FIG. 1 shows a pipetting device 1 according to the invention for taking up and dispensing volumes of fluid.

The pipetting device 1 has a displacement mechanism 10. By means of the displacement mechanism 10, a fluid, in particular a liquid, can be taken up into the pipetting device 1 and subsequently dispensed again from the latter.

The displacement mechanism 10 preferably has a displacement means 11 and a displacement housing 12.

The displacement housing 12 forms a cavity 13 in which the fluid can be taken up. The cavity 13 preferably forms a receptacle for the fluid.

The pipetting device 1 and/or displacement mechanism 10 preferably has an elongate shape or has a longitudinal axis A. The longitudinal axis A preferably runs centrally through the displacement mechanism 10, in particular through the displacement means 11, the displacement housing 12 and/or the cavity 13.

Where terms, such as “axially”, “axial direction” and the like are used below, this preferably refers to the longitudinal axis A. Correspondingly, terms, such as “radially” or “radial direction” or the like also refer to the longitudinal axis A, i.e., to a direction perpendicular to the longitudinal axis A.

The displacement means 11 is preferably movable axially and/or along the longitudinal axis A.

By means of the displacement means 11, the volume of the receptacle for the fluid or the cavity 13 can preferably be changed such that, when the cavity 13 is enlarged, the arising negative pressure makes it possible to draw fluid into the cavity 13 and, when the volume is reduced, makes it possible for the fluid to be dispensed again or pushed out of the cavity 13.

The displacement mechanism 10 is particularly preferably a piston-cylinder arrangement, or the displacement means 11 is configured as a piston and the displacement housing 12 as a cylinder.

The displacement means 11 is preferably sealed off from the displacement housing 12, in particular by means of a seal 11A.

The displacement mechanism 10 preferably has a resetting means 14, in particular a resetting spring. By means of the resetting means 14, the displacement means 11 is preferably movable or resettable into a starting position, in particular the position where the receptacle for the fluid or the cavity 13 has a maximum volume, and/or in the drawing-in direction of the fluid or counter to the dispensing direction of the fluid.

The displacement mechanism 10 preferably forms a shaft 15 of the pipetting device 1 or is arranged in the shaft 15.

The displacement housing 12 is preferably formed by the shaft 15.

The displacement mechanism 10 preferably has an endpiece 16 or forms an endpiece 16.

The endpiece 16 is preferably formed by the shaft 15 and/or integrally with the displacement housing 12.

The endpiece 16 is preferably configured to connect the pipetting device 1 or the displacement mechanism 10 to a pipette tip 2.

A pipette tip 2 is preferably an in particular at least substantially cone-shaped or conical, tube with two opposite openings, the respective cross section of which differs. The pipette tip 2 can be plugged with the larger opening 2A onto the endpiece 16. Fluid can then be sucked via the pipette tip 2 and the endpiece 16 into the cavity 13 and subsequently dispensed again via the endpiece 16 and the pipette tip 2.

Pipette tips 2 which are usable with the pipetting device 1 can have different geometries, for example different lengths, opening angles or the like.

The endpiece 16 is configured for connection to pipette tips 2 of different geometries and can preferably be exchanged as a part which is separate from the shaft 15.

The pipette tip 2 is preferably connectable in a force-fitting, in particular frictionally locking manner, to the endpiece 16, in particular is pluggable onto, or connectable in a form-fitting manner to, the endpiece 16 and is connected gastightly at or to the endpiece 16.

The endpiece 16 and/or a pipette tip 2 plugged onto the endpiece 16 extend/extends preferably along the longitudinal axis A. The longitudinal axis A preferably runs centrally through the endpiece 16 or through a plugged-on pipette tip 2.

The pipetting device 1 preferably has a stroke mechanism 20 by means of which the displacement mechanism 10, in particular the displacement means 11, can be actuated.

The stroke mechanism 20 preferably has a stroke rod 21 which extends axially and/or along the longitudinal axis A. The stroke rod 21 is preferably movable in the axial direction and/or in the direction of the displacement means 11.

The stroke mechanism 20 preferably has an operating element 22 by means of which the stroke mechanism 20 can be actuated.

An actuation of the operating element 22, in particular pressing down of the latter, preferably causes the stroke rod 21 to be pressed against the displacement means 11 or to exert a force on the displacement means 11 such that the displacement means 11 is moved in the axial direction or in the direction of the cavity 13 or of the endpiece 16 and reduces the volume of the cavity 13. Accordingly, preferably by actuation of the stroke mechanism 20 or of the operating element 22, fluid can be dispensed from the pipetting device 1, in particular via the endpiece 16 and the pipette tip 2, in particular can be pushed out of the receptacle for the fluid or the cavity 13.

The stroke mechanism 20 or the stroke rod 21 and/or the operating element 22 preferably automatically takes up the unactuated state, in particular by means of resetting by the resetting means 14.

The pipetting device 1 preferably has a housing 1A.

The displacement mechanism 10 and/or the stroke mechanism 20 are/is preferably at least partially arranged in the housing 1A. The shaft 15 preferably forms part of the housing 1A.

The displacement mechanism 10 or the stroke mechanism 20 or the operating element 22 is preferably actuable manually. Alternatively, or additionally. an automated or motorized actuation of the displacement mechanism 10 is also possible.

In the event of a manual actuation, the pipetting device 1, in particular the housing 1A, preferably has a protrusion 1B. The protrusion 1B is preferably formed integrally with the housing 1A, is mounted movably in the housing 1A and/or spans in the radial direction. The protrusion 1B preferably serves as a finger rest for a user (not illustrated) during the actuation of the pipetting device 1 or of the displacement mechanism 10 or of the stroke mechanism 20 or of the operating element 22.

The stroke of the stroke mechanism 20 or of the stroke rod 21 or of the displacement means 11 is preferably limited or limitable by a first stop 24 and/or a second stop 25.

The stroke rod 21 preferably has a stop portion 23. The stop portion 23 is preferably formed integrally with the stroke rod 21 and/or extends from the stroke rod 21 in the radial direction and/or is in the manner of a flange.

When the pipetting device 1, displacement mechanism 10, stroke mechanism 20 or operating element 22 is actuated, in particular during movement of the stroke rod 21 in the axial direction, the stop portion 23 preferably comes to a stop against the second stop 25, which limits the axial movement or stroke movement.

When the pipetting device 1 or the displacement mechanism 10 or the stroke mechanism 20 is reset, in particular by means of the resetting means 14, the stop portion 23 preferably comes to a stop against the first stop 24, which limits the axial movement or stroke movement.

When the stop portion 23 stops against the first stop 24, the unactuated state is preferably reached and/or the volume in the cavity 13 is at maximum. In particular, the maximum volume of fluid which can be taken up is defined by the position of the first stop 24.

Preferably, the axial position of the first stop 24 and/or the maximum volume of fluid which can be taken up or the volume of the cavity 13 is adjustable or settable. For this purpose, the pipetting device 1 or the stroke mechanism 20 preferably has a setting means 26.

Preferably, a threaded connection 27 is formed between the setting means 26 and the first stop 24 and/or the setting means 26 has an internal thread and the first stop 24 has a corresponding external thread.

The axial position of the first stop 24 and therefore the maximum volume of fluid which can be taken up can be set via the threaded connection 27.

The pipetting device 1 preferably has a display means 28 which is coupled to the setting means 26 and displays the maximum volume of fluid which has been set.

The pipetting device 1 or stroke mechanism 20 can be configured for an overstroke. In this case, the second stop 25 preferably forms an overstroke stop. The second stop 25 is clamped into its stop position preferably by means of an overstroke spring 29. When the stop portion 23 comes to a stop against the second stop 25, application of an additional force enables the second stop 25 to be moved in the axial direction counter to the spring force of the overstroke spring 29 such that an over-stroke can occur.

According to the invention, the pipetting mechanism 1 has an ejector mechanism 30 for releasing or separating or ejecting the pipette tip 2, and an actuating mechanism or an actuating means 40 in order to actuate or to activate the ejector mechanism 30.

The pipetting device 1 preferably has a coupling mechanism 50 for coupling the actuating means 40 to the ejector mechanism 30, and/or a positioning mechanism 60 for positioning the ejector mechanism 30, in particular an ejector means 31 of the ejector mechanism 30, in a basic position.

In the following, the construction and the interaction of the ejector mechanism 30, the actuating means 40, the coupling mechanism 50 and the positioning mechanism 60 will be explained in more detail with reference to FIGS. 1 to 4 which show the pipetting mechanism 1 according to a first embodiment in various positions or actuating positions.

FIG. 1 shows the pipetting device 1 before the plugging on of the pipette tip 2 with the actuating means 40 unactuated. The unactuated position of the actuating means 40 is referred to below as the inoperative position.

The ejector mechanism 30 preferably has an ejector means 31, in particular an ejector sleeve.

The ejector means 31 is preferably configured in the manner of a cylinder and/or at least partially surrounds the displacement mechanism 10 or the shaft 15 and/or forms a sleeve.

FIG. 1 shows the ejector mechanism 30 or the ejector means 31 in a basic position. The basic position is preferably the position in which the endpiece 16 is free or in which a pipette tip 2 is not plugged on. In the basic position, the ejector mechanism 30 or the actuating means 40 is preferably unactuated, in particular the actuating means 40 is in the inoperative position.

In the basic position, the endpiece 16 preferably protrudes, in particular axially, out of the ejector mechanism 30 or the ejector means 31. The ejector means 31 preferably has an opening 31A which is arranged in particular at an axial end of the ejector means 31 and through which the endpiece 16 extends in the basic position or from which the endpiece 16 protrudes in the basic position.

The ejector means 31 preferably at least partially surrounds the endpiece 16 radially.

However, solutions are also possible in which the endpiece 16 is completely surrounded by the ejector means 31 or does not protrude out of the opening 31A. For example, the opening 31A could also be closed with a cap or the like which then has to be removed before a pipette tip 2 is used or plugged on.

The longitudinal axis A preferably extends, in particular centrally, through the ejector means 31 or the opening 31A.

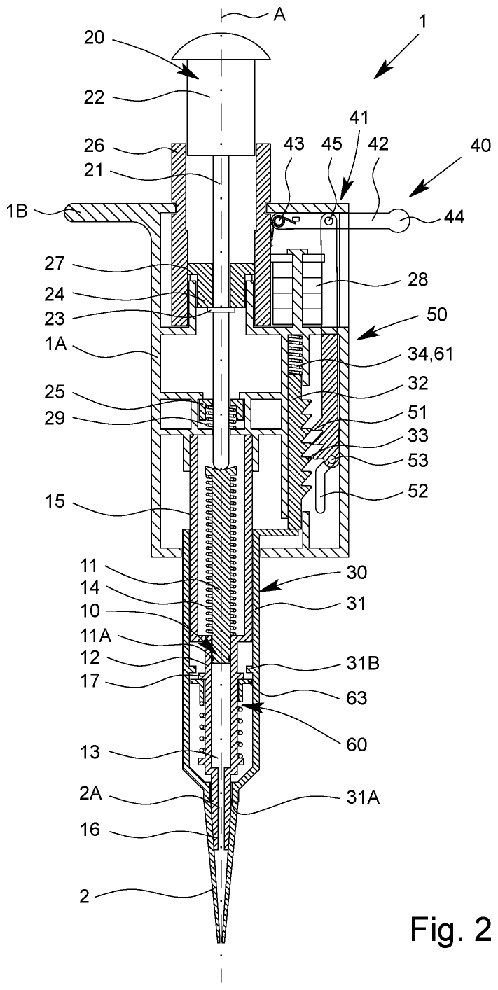

FIG. 2 shows the pipetting device 1 with plugged-on pipette tip 2. The actuating means 40 is unactuated or is in the inoperative position. FIG. 2 therefore shows the pipetting device 1 in the use state in which, as described at the beginning, fluid can be taken up and dispensed via the plugged-on pipette tip 2.

The pipette tip 2 is plugged onto the pipetting device 1 or the endpiece 16 preferably in the axial direction or in a plug-on direction R1.

The plug-on direction R1 is illustrated by an arrow in FIG. 1. It preferably corresponds to the direction of the receptacle for the fluid or the resetting direction of the displacement mechanism 10, in particular of the displacement means 11, or of the stroke mechanism 20. The plug-on direction R1 is in particular opposed to the dispensing direction of the fluid or to the direction of movement of the stroke mechanism 20, in particular of the stroke rod 21 or of the displacement means 11 when the stroke mechanism 20, in particular the operating element 22, is actuated.

As already mentioned at the beginning, the plugging on of the pipette tip 2 in the plug-on direction R1 should be understood as meaning a relative movement between pipetting device 1 and pipette tip 2. Conventionally, for the plugging on, the pipetting device 1 or the endpiece 16 is moved towards the (unmoved) pipette tip 2 or pressed into the pipette tip 2 or into the opening 2A thereof, i.e. the pipetting device 1 is moved towards the pipette tip 2 counter to the plug-on direction R1. This corresponds to a relative movement of the pipette tip 2 in the plug-on direction R1.

The plug-on direction R1 is preferably defined solely by the pipetting device 1, namely as the direction in which (any desired) pipette tip 2 can be plugged onto the endpiece 16. In particular, the plug-on direction R1 does not depend on the pipette tip 2 used.

When the pipette tip 2 is plugged on, the ejector mechanism 30 or the ejector means 31 is preferably displaced in the axial direction or in the plug-on direction R1.

In the state shown in FIG. 2 or with the pipette tip 2 plugged on, the ejector mechanism 30 or the ejector means 31 is preferably in a plug-on position which is different from the basic position. In the plug-on position, the ejector mechanism 30 or the ejector means 31 is shifted or displaced in relation to the basic position in the plug-on direction R1. In particular, in the plug-on position, the endpiece 16 protrudes further out of the ejector means 31 or the opening 31A than in the basic position.

In the plug-on position, the axial end of the ejector means 31 preferably is located on the pipette tip 2.

The plug-on position can differ for different pipette tips 2 depending on the geometry of the pipette tip 2 used. In particular, the pipette tip 2 can be plugged to a differing degree onto the endpiece 16 in order to produce a stable (frictionally locking) connection between pipette tip 2 and endpiece 16. This can vary, for example, with the opening angle or the radius of the opening 2A. Accordingly, depending on the pipette tip 2, the ejector means 31 can be displaced to a greater or lesser extent from the basic position in the plug-on direction R1.

The plug-on position is particularly preferably defined by the ejector means 31 lying directly on the pipette tip 2 or on the openings 2A and 31A, i.e. depends on the extent to which the pipette tip 2 is pushed or plugged onto the endpiece 16.

In order to separate or eject or release the pipette tip 2 from the pipetting device 1, in particular from the endpiece 16, a user can actuate the actuating means 40 or activate the ejector mechanism 30.

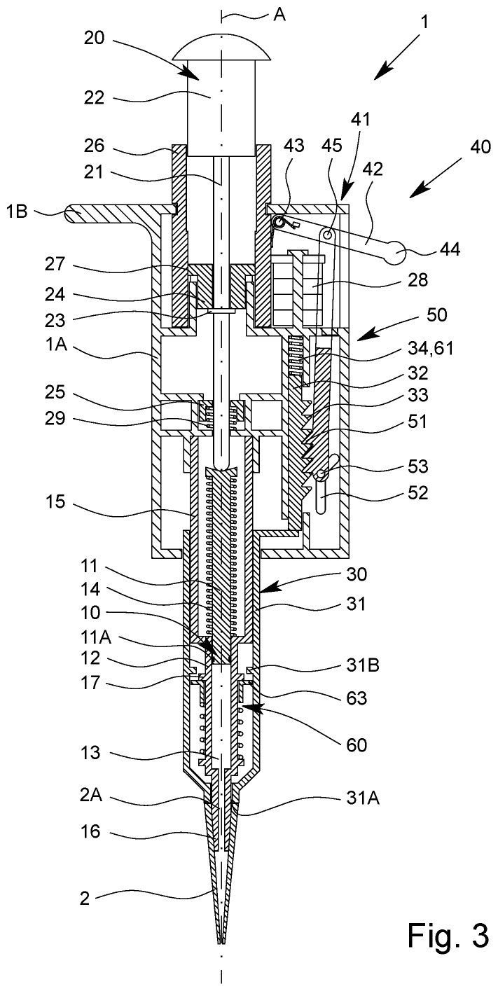

FIG. 3 shows the actuating means 40 in a partially actuated position or intermediate position or coupling position, which will be discussed in more detail later. In this position, the ejector mechanism 30 or the ejector means 31 is (still) in the plug-on position, or the pipette tip 2 is (still) connected to the pipetting device 1 or to the endpiece 16 or plugged thereon.

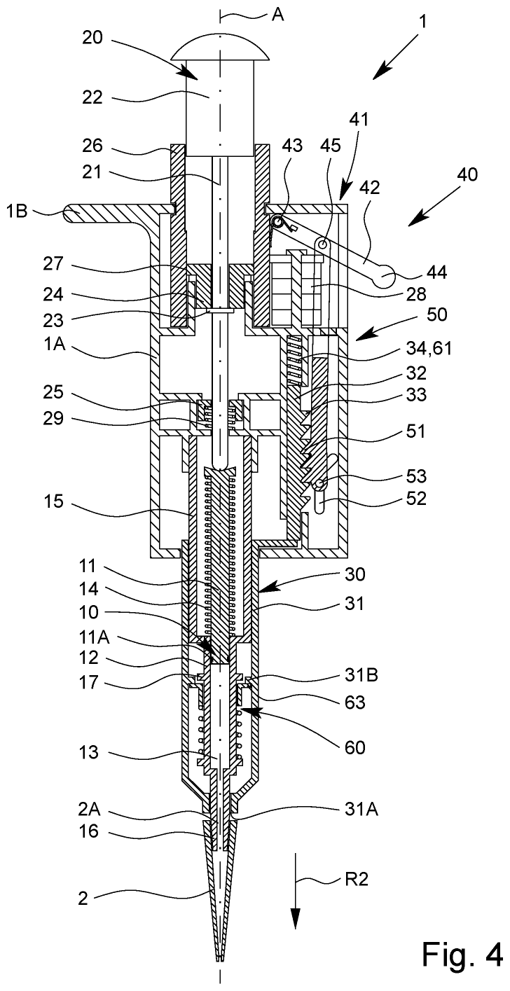

FIG. 4 shows the pipetting device 1 with the actuating means 40 (completely) actuated. The actuated position of the actuating means 40 is referred to below as the actuating position. By actuation of the actuating means 40, the actuating means 40 is preferably brought out of its inoperative position, in particular via an intermediate position or coupling position, into the actuating position.

The movement of the actuating means 40 into the actuating position preferably brings about a movement of the ejector mechanism 30 or of the ejector means 31 counter to the plug-on direction R1 or in an ejection direction R2 or into an ejection position which is illustrated in FIG. 4.

The ejection direction R2 is preferably opposite to the plug-on direction R1 and/or is in the direction of the dispensing of the fluid or in the direction of the displacement means 11 or of the stroke rod 21 when the operating element 22 is actuated, and/or is opposed to the receiving direction of the fluid or to the resetting direction of the displacement means 11 or of the stroke rod 21.

By means of the movement of the ejector means 31 in the ejection direction R2 or from the plug-on position into the ejection position, a force is preferably exerted in the axial direction on the pipette tip 2 by the ejector means 31, the force pushing the pipette tip 2 from the pipetting device 1 or the endpiece 16 and separating or ejecting it therefrom. In particular, the pipette tip 2 is pushed down from the pipetting device 1 or the endpiece 16 by the ejector means 31.

As already mentioned previously, the ejector means 31 preferably is located axially on the pipette tip 2 in the plug-on position such that, when the ejector means 31 is moved into the ejection position, force is directly transmitted to the pipette tip 2, or such that no empty stroke arises in which the ejector means 31 has first to be moved towards the pipette tip 2 before force is transmitted.

The ejection position preferably differs from the basic position. In particular, in the ejection position, the ejector mechanism 30 or the ejector means 31 is displaced further in the ejection direction R2 than in the basic position, and/or, in the ejection position, the endpiece 16 protrudes less far out of the ejector means 31 or the opening 31A than in the basic position. However, solutions are also possible in which the basic position and the ejection position are at least substantially identical.

The movement of the ejector means 31 from the plug-on position into the ejection position preferably takes place by means of a connecting element or connecting means 32 which is arranged between the actuating means 40 and the ejector means 31.

An actuation of the actuating means 40 preferably brings about a transmission of force to the connecting means 32 such that the latter moves in the axial direction or in the ejection direction R2. The connecting means 32 and the ejector means 31 are preferably operatively connected or operatively connectable such that the movement of the connecting means 32 is transmitted or transmittable to the ejector means 31.

The connecting means 32 is particularly preferably configured as an ejector slide or, upon action, pushes the ejector means 31 in the ejection direction R2.

In the illustrated example, the ejector means 31 and the connecting means 32 are two separate components. In particular, a protrusion of the ejector means 31 extends in the radial direction, and the connecting means 32 is located axially on said protrusion. However, solutions are also possible in which ejector means 31 and connecting means 32 are formed integrally or are operatively connected in some other way, for example, also only indirectly.

The movement of the ejector means 31 in the plug-on direction R1 preferably brings about a movement of the connecting means 32 in the plug-on direction R1.

The ejector mechanism 30 preferably has a pre-tensioning element or pre-tensioning means 34, in particular a pre-tensioning spring which is preferably supported on the housing 1A.

By plugging on of the pipette tip 2, in particular by the movement of the ejector means 31 in the plug-on direction R1, the pre-tensioning means 34 can preferably be clamped, in particular compressed.

The pre-tensioning force or spring force of the pre-tensioning means 34 is preferably selected in such a manner that it is smaller than the holding force between pipette tip 2 and endpiece 16. In the state shown in FIG. 2, the pre-tensioning means 34 is therefore preferably clamped and held in the clamped position owing to the force-fitting or frictionally locking connection between pipette tip 2 and endpiece 16.

When the actuating means 40 is actuated, ejector means 31 and connecting means 32 move in the ejection direction R2 such that the pre-tensioning means 34 can (again) (partially) relax. In this way, some of the force or energy applied during the plugging on of the pipette tip 2 can be stored in the pre-tensioning means 34 and released again during the ejection operation.

The pre-tensioning means 34 preferably assists the movement into the ejection position or the ejection of the pipette tip 2. In particular, the pre-tensioning means 34 reduces the force which is required for the ejection and which has to be exerted on the actuating means 40.

The coupling of the ejector mechanism 30 and of the actuating means 40 by means of the coupling mechanism 50 will be explained in more detail below.

In the inoperative position of the actuating means 40, the actuating means 40 and the ejector mechanism 30 are preferably decoupled or are not operatively connected, or the coupling mechanism 50 is configured in such a manner. This decoupled state is illustrated in FIGS. 1 and 2.

In particular, the plugging on of a pipette tip 2 and/or the movement of the ejector mechanism 30, in particular of the ejector means 31 or connecting means 32, into the plug-on position takes place in the decoupled state or does not lead to any action on the actuating means 40.

When the actuating means 40 is actuated, the actuating means 40 and the ejector mechanism 30 are operatively connected or coupled by means of the coupling mechanism 50, or the coupling mechanism 50 is configured for this purpose.

The coupling of actuating means 40 and ejector mechanism 30 is preferably brought about in a position between the inoperative position and actuating position of the actuating means 40, said position being referred to below as the coupling position. The coupling position is illustrated in FIG. 3.

Between the inoperative position and the coupling position of the actuating means 40, the coupling direction 50 is preferably decoupled from the actuating means 40 and/or from the ejector mechanism 30. In particular, ejector mechanism 30 and actuating means 40 are decoupled or are not operatively connected.

A movement or actuation of the actuating means 40 from the inoperative position into the coupling position preferably brings about a coupling between the coupling mechanism 50 and the actuating means 40 and/or the ejector mechanism 30, in particular between the actuating means 40 and the ejector mechanism 30 by means of the coupling mechanism 50. When the actuating means 40 is moved or actuated from the inoperative position into the coupling position, force is preferably (still) not transmitted to the ejector mechanism 30.

Between the coupling position and the actuating position of the actuating means 40, the actuating means 40 and the ejector mechanism 30 are preferably operatively connected or coupled by means of the coupling mechanism 50.

A movement or actuation of the actuating means 40 from the coupling position into the actuating position preferably brings about a transmission of force from the actuating means 40 via the coupling mechanism 50 to the ejector mechanism 30, in particular such that the ejector mechanism 30, in particular the ejector means 31, is moved or is movable in the ejection direction R2. This is illustrated in FIG. 4.

During the, preferably automatic, resetting of the actuating means 40 from the actuating position into the inoperative position, actuating means 40 and ejector mechanism 30 are preferably decoupled (again), in particular when or shortly after the coupling position is reached, or the coupling mechanism 50 is configured for this purpose.

The coupling mechanism 50 is preferably permanently (operatively) connected to the actuating means 40, in particular via a bearing 45. Accordingly, the coupling and decoupling preferably take place by an (operative) connection and separation between coupling mechanism 50 and ejector mechanism 30, in particular connecting means 32. However, other solutions are also possible here in which an (operative) connection between actuating means 40 and coupling mechanism 50 takes place only when the actuating means 40 is moved out of the inoperative position or into the coupling position, and/or when the coupling mechanism 50 and ejector mechanism 30 are permanently (operatively) connected. The (operative) connection or coupling between coupling mechanism 50 and ejector mechanism 30 is preferably form-fitting, force-fitting and/or frictionally locking.

The coupling of the actuating means 40 or the coupling mechanism 50 to the ejector mechanism 30 is preferably brought about by an, in particular form-fitting, force-fitting and/or frictionally locking, engagement between coupling mechanism 50 and ejector mechanism 30, in particular by connecting means 32.

Preferably, the coupling mechanism has an engagement element or engagement means 51 and the ejector mechanism 30, in particular the connecting means 32, has a complementary configured mating engagement element or mating engagement means 33.

In the inoperative position of the actuating means 40, the engagement means 51 and the mating engagement means 33 are preferably not in engagement.

The coupling mechanism 50 is preferably configured in such a manner that an actuation of the actuating means 40 into the coupling position brings about an engagement of engagement means 51 and mating engagement means 33. Upon further actuation or movement of the actuating means 40 from the coupling position into the actuating position, the engagement means 51 and the mating engagement means 33 preferably remain in engagement such that force can be or is transmitted.

Particularly preferably, the engagement is brought about by a toothing, or the engagement means 51 and the mating engagement means 33 each have mutually complementarily configured toothings or teeth.

The coupling mechanism 50 or the engagement means 51 and/or the mating engagement means 33 are/is received or arranged or movable preferably completely in the housing 1A.

In the illustrated example, the coupling and decoupling is preferably realized by means of a guide, in particular a slotted guide. In particular, the coupling mechanism 50 has a guide slot 52 and a control pin 53 guided in the guide slot 32.

During the movement from the coupling position into the actuating position, the coupling mechanism 50 or the engagement means 51 is preferably guided in such a manner that force is transmitted in the axial direction or in the ejection direction R2 to the ejector mechanism 30, in particular to the connecting means 32 or mating engagement means 33. In particular, the guide or guide slot 52 extends at least substantially in the axial direction or parallel to the longitudinal axis A.

During the movement from the inoperative position into the coupling position, the coupling mechanism 50 or the engagement means 51 is preferably guided in such a manner that coupling occurs in the coupling position.

In the illustrated example, the engagement means 51 is movable linearly towards the mating engagement means 33 in order to bring about the engagement. In particular, the guide or guide slot 52 extends at a right angle or acute angle with respect to the ejection direction R2. However, other solutions are also possible here, for example the engagement means 51 can be rotatable, in particular such that an engagement takes place by means of the rotational movement.

The ejector mechanism 30 and/or coupling mechanism 50 are/is preferably configured in such a manner that an engagement can take place in different (axial) positions of the ejector mechanism 30, in particular of the connecting means 32 or mating engagement means 33.

As already mentioned previously, the plug-on position of the ejector mechanism 30 can differ, depending on the pipette tip 2. The coupling is preferably possible in different plug-on positions. In the illustrated example, this is realized by the teeth which is illustrated. The teeth are arranged in such a manner that, depending on the plug-on position, various teeth of the engagement means 51 and mating engagement means 33 can enter into engagement. However, other solutions are also possible here.

The pipetting device 1 preferably has the positioning mechanism 60. By means of the positioning mechanism 60, the ejector mechanism 30 or the ejector means 31 is preferably held or positioned in the basic position.

The positioning mechanism 60 preferably has a first pre-tensioning means 61 and/or a second pre-tensioning means 62. In particular, the pre-tensioning means 61, 62 are springs.

The first pre-tensioning means 61 is preferably arranged in such a manner that it acts on the ejector mechanism 30 in the ejection direction R2, and/or the second pre-tensioning means 62 is preferably arranged in such a manner that it acts on the ejector mechanism 30 in the plug-on direction R1.

In the illustrated example, the first pre-tensioning means 61 is formed by the pre-tensioning means 34. In particular, assisting of the ejection and also driving or holding of the ejector mechanism 30 in the basic position is therefore brought about the same pre-tensioning means. However, other solutions in which different pre-tensioning means are used are also possible here.

The second pre-tensioning means 62 is preferably arranged on the shaft 15 or displacement housing 12 and/or at least partially surrounds same. The second pre-tensioning means 62 is preferably supported on a radial protrusion formed by the shaft 15 or displacement housing 12, in particular directly above the endpiece 16.

The positioning mechanism 60 preferably has a flange element 63. The flange element 63 preferably at least partially radially surrounds the shaft 15 or the displacement housing 12. The flange element 63 preferably has a portion extending in the radial direction.

In the basic position, the flange element 63 is clamped against a protrusion or stop 17 preferably by the second pre-tensioning means 62.

The protrusion or stop 17 is preferably formed, in particular integrally, by the shaft 15 or the displacement housing 12, and/or protrudes in the radial direction.

The ejector mechanism 30, in particular the ejector means 31, preferably has a protrusion or stop 31B which, in the basic position, is clamped against the flange element 63, in particular by means of the first pre-tensioning means 61. The stop 31B is preferably formed integrally with the ejector means 31 and/or protrudes in the radial direction, in particular in the direction of the shaft 15, displacement housing 12 or stop 17.

In the basic position, the stop 17 and the stop 31B preferably lie at the same height and/or the basic position is preferably defined by the position of the stop 17.

Preferably, in the basic position, the flange element 63 is clamped against the stop 17 by means of the second pre-tensioning means 62 and held in this position, and the ejector means 31 is clamped with its stop 31B against the flange element 63 by means of the first pre-tensioning means 61 such that the ejector means 31 is held or positioned in the basic position.

The functioning of the positioning mechanism 60 of the illustrated example is explained in more detail below with reference to the further FIGS. 2 to 4.

In the plug-on position illustrated in FIGS. 2 and 3, the ejector mechanism 30, in particular the stop 31B, is displaced in the plug-on direction, as a result of which the first pre-tensioning means 61 is clamped, in particular compressed.

In the plug-on position, the stop 31B is preferably lifted off from the flange element 63, as illustrated in FIGS. 2 and 3. The stop 31B is held in this position preferably by the (frictionally locking) connection of pipette tip 2 and endpiece 16, as explained previously for the entire ejector mechanism 30. The flange element 63 is preferably (furthermore) clamped against the stop 17 or held in the same position as in the basic position.

When the pipette tip 2 is ejected or the actuating means 40 is moved into the actuating position, the ejector mechanism 30, in particular the stop 31B, is moved in the ejection direction R2. By this means, the stop 31B and the flange element 63 preferably come to a stop against each other, in particular if the basic position is reached (again).

The ejector mechanism 30 or the stop 31B is preferably moved or displaced beyond the basic position into the ejection position. By this means, the flange element 63 is preferably moved in the ejection direction R2 by means of the stop 31B or lifted off from the stop 17, in particular counter to the clamping force of the second pre-tensioning means 62, as a result of which preferably the second pre-tensioning means 62 is clamped. This is illustrated in FIG. 4.

If no (more) force acts on the flange element 63 in the ejection direction R2, in particular if the actuating means 40 is released or the actuation is ended, the second pre-tensioning means 62 can relax (again). This brings about a force on the flange element 63 in the plug-on direction R1 and, via the flange element 63, on the stop 31B such that the ejector mechanism 30 or the ejector means 31 is moved in the plug-on direction R1.

The movement in the plug-on direction R1 preferably ends when the flange element 63 comes to a stop against the stop 17. A further movement of the ejector means 31 in the plug-on direction R1 is preferably prevented by the oppositely acting force of the first pre-tensioning means 61. The ejector mechanism 30 or the ejector means 31 is then preferably (again) in the basic position or remains in the latter until a new pipette tip 2 is plugged on.

The actuating means 40 is preferably configured for the stepping down or has a step-down mechanism 41. By means of the step-down mechanism 41, the force transmitted to the ejector mechanism 30 by the actuation of the actuating means 40 can be increased.

The actuating means 40 or the step-down mechanism 41 preferably has a lever 42. The lever 42 preferably extends in the radial direction and/or protrudes (radially) out of the housing 1A.

At its first end, the lever 42 is fastened to the housing 1A or connected to the housing 1A preferably by a rotary bearing 43.

The rotary bearing 43 is preferably configured in such a manner that the lever 42 or the actuating means 40 automatically takes up the inoperative position from the actuating position. For this purpose, for example, a resetting spring can be provided.

At is second end, the lever 42 preferably has an actuating button 44, a thickened portion in the illustrated example.

The rotary bearing 45 is preferably arranged between the actuating button 44 and the rotary bearing 43, said rotary bearing 45 connecting the actuating means 40 or the lever 42 to the ejector mechanism 30 or to the coupling mechanism 50.

When the actuating means 40 is actuated, the lever 42 is preferably pivoted about the rotary bearing 43, in particular by (manual) pressing down of the actuating button 44, which brings about a (stepped-down) transmission of force via the rotary bearing 45 to the coupling mechanism 50 or the ejector mechanism 30.

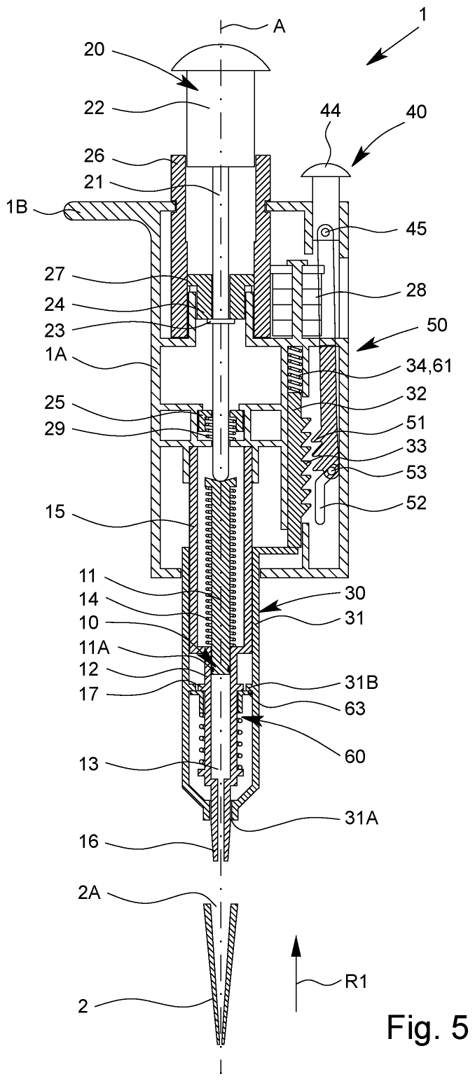

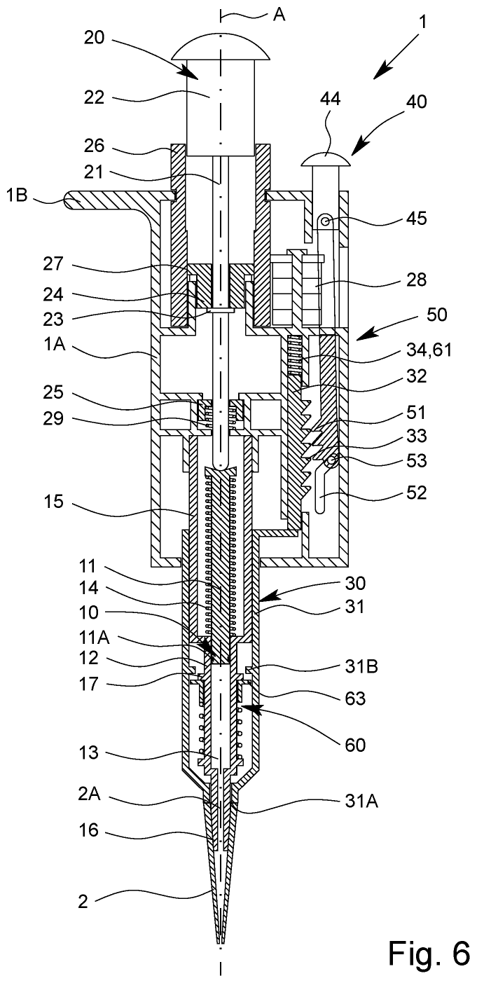

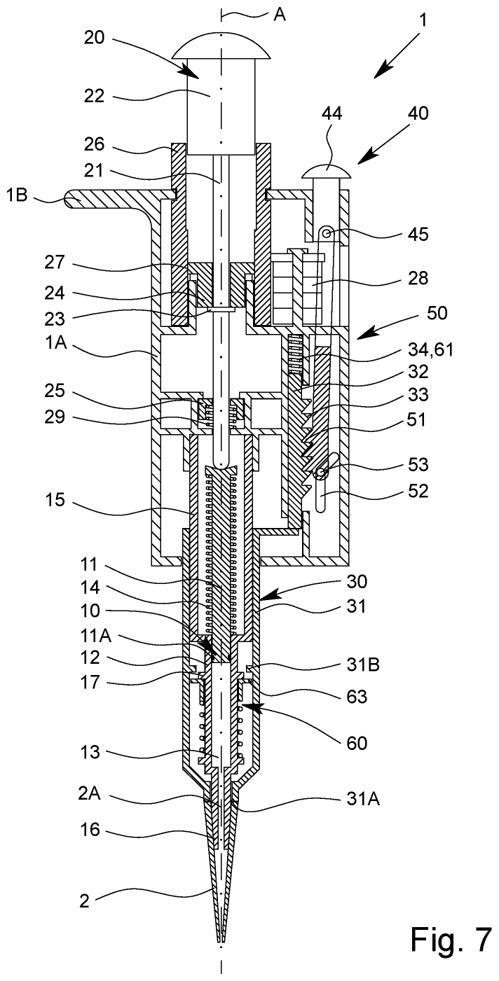

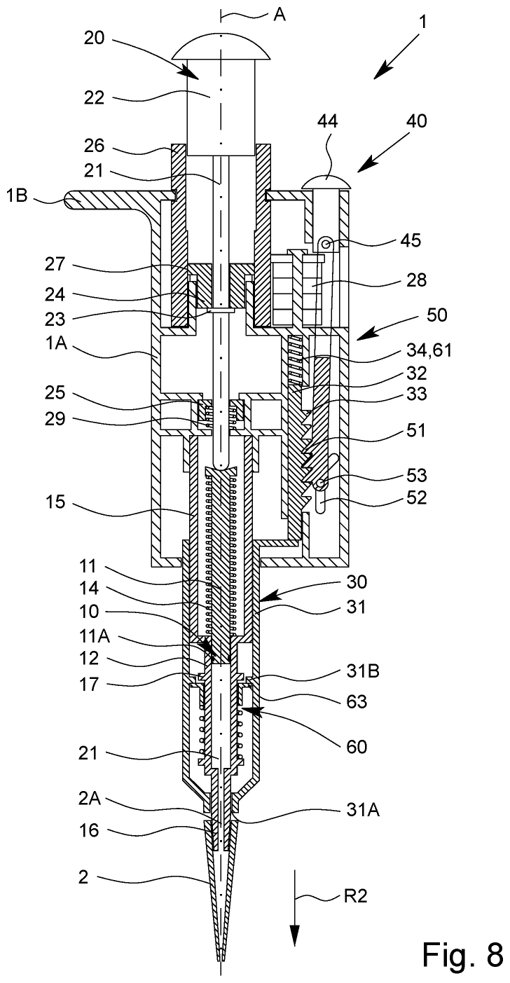

FIGS. 5 to 8 shows the pipetting device 1 according to a second embodiment, wherein the different states or positions in FIGS. 5 to 8 correspond to those of FIGS. 1 to 4.

The second embodiment differs from the first embodiment preferably only in the configuration of the actuating means 40. The previous statements and explanations therefore preferably also apply to the second embodiment, even if this is not explicitly repeated.

In the illustrated example according to the second embodiment, the actuating means 40 is configured as an actuating button 44 without lever 42 or step-down mechanism 41.

The actuating button 44 preferably protrudes axially out of the housing 1A.

The actuating button 44 can preferably be moved or pressed down in the axial direction or in the ejection direction R2, which preferably brings about the coupling described previously in conjunction with the first embodiment and/or the ejection of the pipette tip 2.

The actuating button 44 is preferably connected to the coupling mechanism 50 or ejector mechanism 30 by means of the rotary bearing 45.

Individual aspects of the above-described invention may be realized, and may be advantageous, independently of one another, but also in any desired combination. In particular, the coupling mechanism 50 and the positioning mechanism 60 are two invention aspects which can be realized independently of each other. Solutions are therefore also possible in which only the coupling mechanism 50 is provided, for example solutions in which the basic position and the ejection position are identical. Similarly, solutions are possible in which only the positioning mechanism 60 is provided and in which, for example, the ejector mechanism 30 and the actuating means 40 are permanently operatively connected to each other.

What is claimed is:

1. A pipetting device for taking up and dispensing volumes of fluid, comprising:
a displacement mechanism comprising an endpiece that is configured for the releasable attaching of a pipette tip,
an ejector mechanism having an ejector means for releasing and ejecting a pipette tip attached to the endpiece from the pipetting device,
an actuating means for actuating the ejector mechanism, and
a coupling mechanism interacting with the actuating means and the ejector mechanism,
wherein the actuating means is movable from an inoperative position into an actuating position,
wherein the ejector mechanism is configured in such a manner that, by movement of the actuating means from the inoperative position into the actuating position, the ejector means is movable relative to the endpiece into an ejection position, and a pipette tip attached to the endpiece is movable relative to the endpiece and is ejectable from the pipetting device,
wherein the coupling mechanism is configured in such a manner that, in the inoperative position of the actuating means, the coupling mechanism decouples the actuating means from the ejector mechanism, and
wherein, by movement of the actuating means from the inoperative position into the actuating position, the coupling mechanism couples the actuating means to the ejector mechanism, as a result of which a force exerted on the actuating means is transferrable to the ejector means.

2. The pipetting device according to claim 1, wherein:
by movement of the actuating means into the actuating position, the coupling mechanism is engageable with the ejector mechanism, and/or
in the inoperative position of the actuating means, the coupling mechanism is disengaged with the ejector mechanism, and/or
upon movement of the actuating means from the inoperative position into the actuating position, the actuating means is operatively connected to the coupling mechanism.

3. The pipetting device according to claim 1, wherein the coupling mechanism has an engagement means and the ejector mechanism has a mating engagement means, wherein:
the engagement means can be brought into form-fitting, force-fitting and/or frictionally locking engagement with the mating engagement means, by means of which engagement the actuating means is coupled to the ejector mechanism, and/or
the engagement means and the mating engagement means each have teeth configured to be mutually complementary at least in regions, for interaction, and/or
the engagement means is guided in a housing of the pipetting device, and/or
the engagement means is movable by means of the actuating means, and/or
the engagement means is movably connected to the actuating means, and/or
the engagement means is movable along a longitudinal axis of the pipetting device, and/or
the engagement means is rotatable about an axis running transversely with respect to the longitudinal axis of the pipetting device, and/or
by movement of the actuating means into the actuating position, the mating engagement means is movable when the coupling mechanism is coupled to the ejector mechanism, in particular to the mating engagement means, and/or
the mating engagement means is operatively connected to the ejector means in such a manner that a movement of the mating engagement means brings about a movement of the ejector means.

4. The pipetting device according to claim 1, wherein the pipetting device has a pre-tensioning means for pre-tensioning the ejector means, and wherein the pre-tensioning means exerts a pre-tensioning force on the ejector means counter to an attaching direction of the pipetting device, both when the coupling mechanism is decoupled and also when the latter is coupled.

5. The pipetting device according to claim 1, wherein the ejector means at least partially radially surrounds the endpiece and the endpiece protrudes out of the ejector means through an opening in the ejector means.

6. The pipetting device according to claim 4, wherein the ejector means at least partially radially surrounds the endpiece and the endpiece protrudes out of the ejector means through an opening in the ejector means, wherein the pre-tensioning force of the pre-tensioning means is selected in such a manner that, in the inoperative position of the actuating means, the ejector means remains in a basic position in which the endpiece protrudes equally far or further out of the ejector means than in the ejection position of the ejector means.

7. The pipetting device according to claim 1, wherein, in the inoperative position of the actuating means, the ejector means is movable in an attaching direction of the pipetting device until in a plug-on position.

8. The pipetting device according to claim 7, wherein the pipetting device has a pre-tensioning means for pre-tensioning the ejector means, and wherein the pre-tensioning means exerts a pre-tensioning force on the ejector means counter to an attaching direction of the pipetting device, both when the coupling mechanism is decoupled and also when the latter is coupled, and wherein the pre-tensioning force of the pre-tensioning means is selected in such a manner that, when a pipette tip is attached to the endpiece and is adjacent to the ejector means, the ejector means remains in its plug-on position.

9. The pipetting device according to claim 3, wherein the pipetting device has a pre-tensioning means for pre-tensioning the ejector means, and wherein the pre-tensioning means exerts a pre-tensioning force on the ejector means counter to an attaching direction of the pipetting device, both when the coupling mechanism is decoupled and also when the latter is coupled, and wherein the pre-tensioning force of the pre-tensioning means is selected in such a manner that, when a pipette tip is attached to the endpiece and is adjacent to the ejector means, the ejector means remains in its plug-on position, and wherein the engagement means is engaged with or disengaged from the mating engagement means by movement at least along the longitudinal axis of the pipetting device, wherein the pipetting device has a guide slot in which the engagement means is guided.

10. A pipetting device for taking up and dispensing volumes of fluid comprising:
a displacement mechanism with an endpiece for the releasable attaching of a pipette tip,
an ejector mechanism for releasing and ejecting a pipette tip attached to the endpiece from the pipetting device, wherein the ejector mechanism has an ejector means, and
an actuating means for actuating the ejector mechanism,
wherein the ejector mechanism is configured in such a manner that, by movement of the actuating means from an inoperative position into an actuating position, the ejector means is movable relative to the endpiece into an ejection position, and
a pipette tip attached to the endpiece is movable relative to the endpiece and is finally ejectable from the pipetting device, and
in the inoperative position of the actuating means, the ejector means is movable in an attaching direction of the pipetting device from a basic position into a plug-on position in which the ejector means remains in the event of a pipette tip being attached to the endpiece and being adjacent to the ejector means,
wherein the pipetting device has a positioning mechanism by means of which the ejector means is held in a basic position which is located between the ejection position and the plug-on position.

11. The pipetting device according to claim 10, wherein the positioning mechanism has a first pre-tensioning means, and wherein the first pre-tensioning means exerts a pre-tensioning force on the ejector means counter to the attaching direction of the pipetting device.

12. The pipetting device according to claim 11, wherein the positioning mechanism has a second pre-tensioning means, and wherein the second pre-tensioning means is fastened at one end to the ejector means and at another end to the pipetting device, and holds the ejector means in the basic position.

13. The pipetting device according to claim 10, wherein the positioning mechanism has a second pre-tensioning means, and wherein the second pre-tensioning means exerts a pre-tensioning force on the ejector means in the attaching direction of the pipetting device opposite the direction in which the first pre-tensioning means of the positioning mechanism exerts a pre-tensioning force on the ejector means.

14. The pipetting device according to claim 13, wherein the positioning mechanism has a flange element which is seated movably on the displacement mechanism between a first stop on the displacement mechanism and the second pre-tensioning means,
wherein the second pre-tensioning means pushes the flange element against the first stop,
wherein the ejector means has a second stop which, when the ejector means moves counter to the attaching direction of the pipetting device, abuts against the flange element and, during a further movement of the ejector means, entrains the flange element counter to the action of the pre-tensioning force of the second pre-tensioning means in a manner moving away from the first stop, and
wherein the first pre-tensioning means pushes the ejector means against the flange element counter to the attaching direction of the pipetting device and holds the ejector means in the basic position.

15. The pipetting device according to claim 12, wherein, when the actuating means is shifted from the actuating position into the inoperative position, the ejector means is moved into its basic position by the pre-tensioning force of the second pre-tensioning means.

16. The pipetting device according to claim 1, wherein the actuating means has a step-down mechanism for the actuation from the inoperative position into an actuating position.
